(19) United States
(12) Patent Application Publication
(10) Pub. No.: US 2010/0079243 A1
(43) Pub. Date: Apr. 1, 2010

(54) AUTHENTICATION SYSTEM, AUTHENTICATION METHOD, AND AUTHENTICATION PROGRAM

(76) Inventor: Yasushi Hamada, Tokyo (JP)

Correspondence Address: Mr. Jackson Chen, 6535 N. STATE HWY 161, IRVING, TX, 75039, US

(21) Appl. No.: 12/408,174

(22) Filed: Mar. 20, 2009

(30) Foreign Application Priority Data
Mar. 26, 2008 (JP) 2008-079505

(51) Int. Cl. G06F 7/04; H04Q 5/22

(52) U.S. Cl. 340/5.83; 340/10.42

(57) ABSTRACT

An object of an exemplary embodiment of the present invention is to provide an authentication system which can perform highly convenient authentication while ensuring minimum required authentication accuracy. An authentication system of an exemplary embodiment of the present invention includes a first authentication device which acquires a first authentication level, a second authentication device which acquires a second authentication level, and an authentication verifying device which authenticates based on a comparison between a predetermined value and a sum of the first authentication level and the second authentication level.

### BACKGROUND OF THE INVENTION

1. Field of the Invention

The present invention relates to an authentication system, an authentication method, and an authentication program, and particularly to an authentication system, an authentication method, and an authentication program which authenticate using a plurality of authentication devices.

2. Description of the Related Art

In authentication systems, authentication of a person is performed using a plurality of authentication devices including a unit which authenticates an ID card, biologic information, or the like.

Japanese Patent Laid-Open No. 2007-025934 discloses a technology which allows a second terminal to authenticate only a person authenticated by a first terminal and thereby prevents a person who is not authenticated in a correct order from using a terminal illegally (hereinafter referred to as related art 1).

In addition, Japanese Patent Laid-Open No. 2005-146709 discloses a technology in which a person authenticated using an ID card and face authentication at admission once, is authenticated only by face authentication at the second time or later authentication (hereinafter referred to as related art 2).

In addition, Japanese Patent Laid-Open No. 1999-355267 discloses a technology in which when authentication is performed multiple times, an authentication method of secondary authentication is verified based on an authentication content of primary authentication (hereinafter referred to as related art 3). In other words, if sufficiently strong authentication is performed at the primary authentication, the requirement of the secondary authentication is relaxed.

An authentication system of the above related art 1 or 2 includes a plurality of authentication devices, and a criterion value with respect to an authentication result is set in each authentication device. In such authentication system of the related arts, authentication is not allowed unless an authentication result becomes greater than or equal to a respective criterion value in each authentication device. Therefore, if the authentication device is a face authentication device, a face direction and lighting may have to be adjusted so that an authentication result becomes greater than or equal to a respective criterion value. As described above, there is the inconvenience that a face direction and lighting needs to be adjusted until an authentication result becomes greater than or equal to a criterion value. On the other hand, when a criterion value is set such that the requirement of authentication is relaxed in each authentication device, a respective authentication level can easily be greater than or equal to the criterion value. Thereby, the need to adjust a face direction and lighting is reduced and the convenience is enhanced. However, this method has a problem that a person is determined to be a registered person in all authentication devices even if respective authentication processing results are constantly less than original criterion values, and therefore minimum required authentication accuracy cannot be ensured.

In related art 3, sufficiently strong authentication is required at a primary authentication, and authentication is not allowed until an authentication result becomes greater than or equal to a criterion value. This is inconvenient since a secondary authentication is not performed unless authentication is allowed at a primary authentication.

An object of the present invention is to provide an authentication system which can perform highly convenient authentication while ensuring minimum required authentication accuracy.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The exemplary embodiments of an authentication system of the present invention includes a first authentication device which acquires a first authentication level, a second authentication device which acquires a second authentication level, and an authentication verifying device which authenticates based on a comparison between a predetermined value and a sum of the first authentication level and the second authentication level.

In the exemplary embodiments of the present invention, authentication of a person is performed based on a sum of authentication levels obtained by a plurality of authentication devices. Therefore, minimum required authentication accuracy can be ensured even if authentication levels of some of the plurality of authentication devices are low. In addition, since a person can be authenticated even if authentication levels of some of the plurality of authentication devices are low, an authentication level does not necessarily need to become greater than or equal to a criterion value in each of the authentication devices, and a highly convenient authentication system can be provided.

### BRIEF DESCRIPTION OF THE DRAWINGS

FIG. 1 is a block diagram showing a configuration of a first exemplary embodiment of the present invention;

FIG. 2 is a block diagram showing a configuration of the first exemplary embodiment of the present invention;

FIG. 3 is a flowchart showing operation of the first exemplary embodiment of the present invention;

FIG. 4 is a block diagram showing a configuration of a second exemplary embodiment of the present invention;

FIG. 5 is a block diagram showing a configuration of the second exemplary embodiment of the present invention;

FIG. 6 is a flowchart showing operation of the second exemplary embodiment of the present invention;

FIG. 7 is a flowchart showing operation of a first authentication device 1000 of the second exemplary embodiment of the present invention;

FIG. 8 is a block diagram showing a configuration of a first example of the present invention;

FIG. 9 is a flowchart showing operation of the first example of the present invention;

FIG. 10 is a flowchart showing operation of a first authentication device 1000 of the first example of the present invention;

FIG. 11 is a block diagram showing a configuration of a second example of the present invention;

FIG. 12 is a flowchart showing operation of the second example of the present invention;

FIG. 13 is a flowchart showing operation of a first authentication device 1000 of a third example of the present invention;

FIG. 14 is a block diagram showing a configuration of a third exemplary embodiment of the present invention; and

FIG. 15 is a flowchart showing operation of a first authentication device 1000 of the third exemplary embodiment of the present invention.

### DETAILED DESCRIPTION OF THE PREFERRED EMBODIMENTS

The exemplary embodiments of the present invention will be described in detail with reference to the drawings.

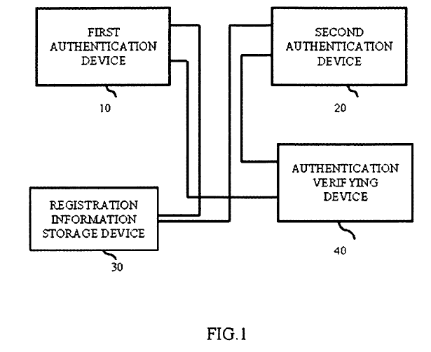

A first exemplary embodiment of the authentication system of the present invention will be described with reference to FIG. 1. The authentication system of the present embodiment includes a first authentication device 10, a second authentication device 20, a registration information storage device 30, and an authentication verifying device 40. The first authentication device 10 and the second authentication device 20 read biologic information, an ID card, or the like to authenticate processing. The registration information storage device 30 stores registered authentication information such as biologic information and ID information of a registered person. The authentication verifying device 40 controls an authentication level to authenticate a person.

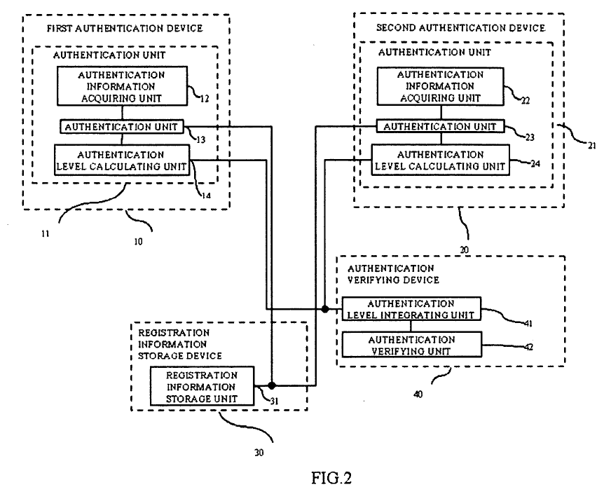

Configurations of the first authentication device 10, the second authentication device 20, the registration information storage device 30, and the authentication verifying device 40 will be described in detail with reference to FIG. 2.

The first authentication device 10 includes a first authentication unit 11. The authentication unit may be composed of two or more units.

The first authentication unit 11 includes an authentication information acquiring unit 12, an authentication unit 13, and an authentication level calculating unit 14. The authentication information acquiring unit 12 acquires authentication information of an authentication target person. The acquired authentication information is, for example, authentication target biologic information and ID tag information. The authentication unit 13 compares the authentication information acquired by the authentication information acquiring unit 12 with registered authentication information, and outputs an authentication result. The registered authentication information is inputted from the registration information storage device 30. The authentication level calculating unit 14 outputs an authentication level based on the authentication result outputted from the authentication unit 13. The authentication level calculating unit 14 may receive the registered authentication information from the registration information storage device 30 and calculate an authentication level based on the authentication result and the registered authentication information. The authentication level represents whether the authentication target person is a registered person or not. Alternatively, the authentication level may represent a probability that the authentication target person is a registered person.

The second authentication device 20 includes an authentication unit 21. The second authentication device 20 may be composed of two or more authentication units.

The authentication unit 21 includes an authentication information acquiring unit 22, an authentication unit 23, and an authentication level calculating unit 24. The authentication information acquiring unit 22 acquires authentication information of an authentication target person. The acquired authentication information is, for example, authentication target biologic information and ID tag information. The authentication unit 23 compares the authentication information acquired by the authentication information acquiring unit 22 with registered authentication information, and outputs an authentication result. The registered authentication information is inputted from the registration information storage device 30. The authentication level calculating unit 24 outputs an authentication level based on the authentication result outputted from the authentication unit 23. The authentication level calculating unit 24 may receive the registered authentication information from the registration information storage device 30 and calculate an authentication level based on the authentication result and the registered authentication information. The authentication level represents whether the authentication target person is a registered person or not. Alternatively, the authentication level may represent a probability that the authentication target person is a registered person.

A registration information recording device 30 includes a registration information storage unit 31. The registration information storage unit 31 stores registered authentication information of an authentication target person. The registered authentication information is preregistered and used in the authentication units 13, 23. The registered authentication information includes at least biologic information such as face, fingerprint, vein, palm print, iris, or voice print information and ID information such as an RFID tag or an optical ID tag.

An authentication verifying device 40 includes an authentication level integrating unit 41 and an authentication verifying unit 42. The authentication level integrating unit 41 integrates authentication levels which are respectively outputted from the first authentication device and the second authentication device, and outputs an integrated authentication level. The integrated authentication level is generated as a sum of authentication levels which are respectively outputted from the first authentication device and the second authentication device. The integrated authentication level may he generated by another integration method. The authentication verifying unit 42 verifies whether an authentication target person is a registered person or not based on the integrated authentication level outputted from the authentication level integrating unit 41. The authentication verifying unit 42 performs verification by comparing a predetermined value with the integrated authentication level. If the integrated authentication level is greater than the predetermined value, the authentication target person is identified as a registered person.

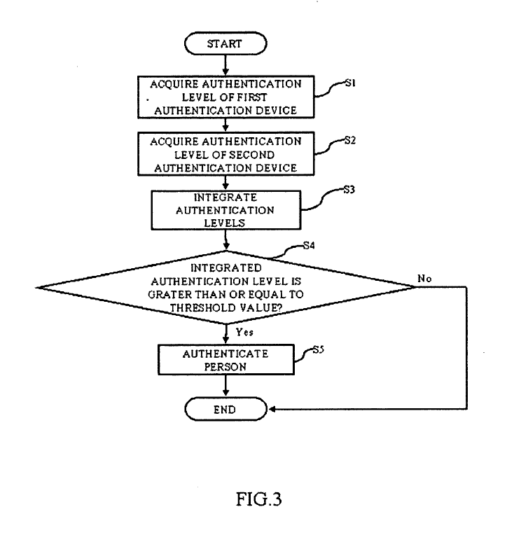

The operation of the present embodiment will be described in detail with reference to FIG. 3.

First, the first authentication device 10 acquires an authentication level of an authentication target person (S1). Then, the second authentication device 20 acquires an authentication level of the authentication target person in a similar manner (S2). The authentication level integrating unit 41 integrates the authentication levels acquired by the first authentication device 10 and the second authentication device 20 (S3). The authentication level integrating unit 41 sums all the authentication levels to integrate them. In a case where an authentication device includes a plurality of authentication units, the authentication level integrating unit 41 may select the maximum authentication level for each authentication device and sum and integrate the selected authentication levels.

The authentication verifying unit 42 performs verifyication by comparing the integrated authentication level integrated by the authentication level integrating unit 41 with a predetermined value (S4). The predetermined value may be a threshold value of authentication level. The threshold value may be above an integrated value of authentication levels outputted from some of the authentication devices. If the authentication level is greater than or equal to the threshold value, the authentication target person is determined to be a registered person and authenticated (S5).

The authentication system of the present embodiment integrates authentication levels which are respectively acquired by the first and second authentication devices, and authenticates according to the sum of the authentication levels, so that minimum required authentication accuracy can be ensured. Further, since an authentication method which acquires a low authentication level is allowed in the first authentication device, highly convenient authentication can be performed.

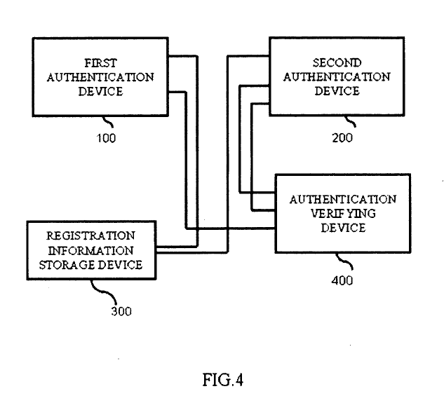

A second exemplary embodiment of the authentication system of the present invention will be described with reference to FIG. 4. The authentication system of the present embodiment includes a first authentication device 100, a second authentication device 200, a registration information storage device 300, and an authentication verifying device 400. The first authentication device 100 and the second authentication device 200 read biologic information, an ID card, or the like to authenticate processing. The registration information storage device 300 stores registered authentication information such as biologic information and ID information of a registered person. The authentication verifying device 400 authenticates an authentication target person based on authentication levels acquired by the first authentication device 100 and the second authentication device 200.

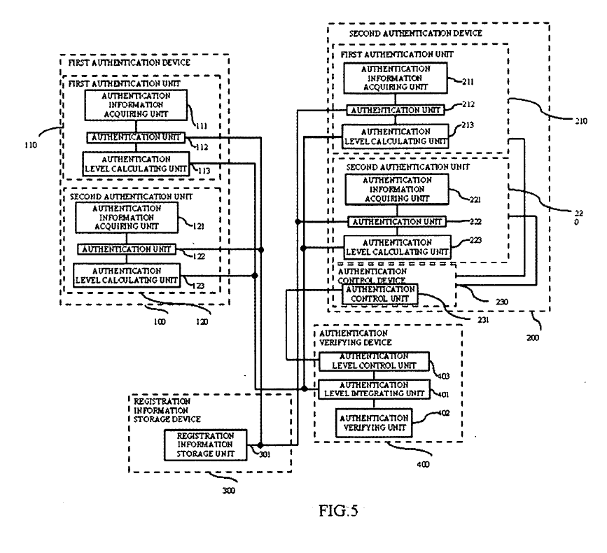

Configurations of the first authentication device 100, the second authentication device 200, the registration information storage device 300, and the authentication verifying device 400 will be described in detail with reference to FIG. 5.

The first authentication device 100 includes a first authentication unit 110, and a second authentication unit 120 which performs processing by a second authentication method different from a first authentication method. The authentication units may be three or more units.

The first authentication unit 110 includes an authentication information acquiring unit 111, an authentication unit 112, and an authentication level calculating unit 113. The authentication information acquiring unit 111 acquires authentication information of an authentication target person. The acquired authentication information is, for example, authentication target biologic information and ID tag information. The authentication unit 112 compares the authentication information acquired by the authentication information acquiring unit 111 with registered authentication information, and outputs an authentication result. The registered authentication information is inputted from the registration information storage device 300. The authentication level calculating unit 113 outputs an authentication level based on the authentication result outputted from the authentication unit 112. The authentication level calculating unit 113 may receive the registered authentication information from the registration information storage device 300 and calculate an authentication level based on the authentication result and the registered authentication information. The authentication level represents whether the authentication target person is a registered person or not. Alternatively, the authentication level may represent a probability that the authentication target person is a registered person.

The second authentication unit 120 includes an authentication information acquiring unit 121, an authentication unit 122, and an authentication level calculating unit 123. The authentication information acquiring unit 121 has an acquisition method different from that of the authentication information acquiring unit 111. The authentication unit 122 compares authentication information acquired by the authentication information acquiring unit 121 with registered authentication information, and outputs an authentication result. The registered authentication information is inputted from the registration information storage device 300. The authentication level calculating unit 123 outputs an authentication level based on the authentication result outputted from the authentication unit 122. The authentication level calculating unit 123 may receive the registered authentication information from the registration information storage device 300 and calculate an authentication level based on the authentication result and the registered authentication information. The first authentication device 100 may be composed of one authentication processing unit or may be composed of three or more authentication units.

The second authentication device 200 includes a first authentication unit 210, a second authentication unit 220 which performs processing by a second authentication method different from a first authentication method, and an authentication control device 230. The authentication units may be three or more units.

The first authentication unit 210 includes an authentication information acquiring unit 211, an authentication unit 212, and an authentication level calculating unit 213. The authentication information acquiring unit 211 acquires authentication information of an authentication target person. The acquired authentication information is, for example, authentication target biologic information and ID tag information. The authentication unit 212 compares the authentication information acquired by the authentication information acquiring unit 211 with registered authentication information, and outputs an authentication result. The registered authentication information is inputted from the registration information storage device 300. The authentication level calculating unit 213 outputs an authentication level based on the authentication result outputted from the authentication unit 212. The authentication level calculating unit 213 may receive the registered authentication information from the registration information storage device 300 and calculate an authentication level based on the authentication result and the registered authentication information. The authentication level represents whether the authentication target person is a registered person or not. Alternatively, the authentication level may represent a probability that the authentication target person is a registered person. The second authentication unit 220 includes an authentication information acquiring unit 221, an authentication unit 222, and an authentication level calculating unit 223. The authentication information acquiring unit 221 has an acquisition method different from that of the authentication information acquiring unit 211. The authentication unit 222 compares authentication information acquired by the authentication information acquiring unit 221 with registered authentication information, and outputs an authentication result. The registered authentication information is inputted from the registration information storage device 300. The authentication level calculating unit 223 outputs an authentication level based on the authentication result outputted from the authentication unit 222. The authentication level calculating unit 223 may receive the registered authentication information from the registration information storage device 300 and calculate an authentication level based on the authentication result and the registered authentication information. The authentication device may be composed of three or more authentication units.

When the first authentication unit 210 or the second authentication unit 220 receives a reauthentication instruction from the authentication control device 230, it requests the authentication target person to be authenticated.

The authentication control device 230 includes an authentication control unit 231. The authentication control unit 231 receives a request for reauthentication from an authentication level control unit 403, and then outputs a reauthentication instruction to the first authentication unit 210 or the second authentication unit 220.

The registration information storage device 300 includes a registration information storage unit 301. The registration information storage unit 301 stores registered authentication information of an authentication target person. The registered authentication information is preregistered and used in the authentication units 112, 122, 212, 222.

An authentication verifying device 400 includes an authentication level integrating unit 401, an authentication verifying unit 402, and the authentication level control unit 403. The authentication level integrating unit 401 integrates authentication levels which are respectively outputted from the first authentication device and the second authentication device, and outputs a final integrated authentication level. The integrated authentication level is generated as a sum of authentication levels which are respectively outputted from the first authentication device and the second authentication device. The integrated authentication level may be integrated by another integration method. The authentication verifying unit 402 verifies whether an authentication target person is a registered person or not based on the integrated authentication level outputted from the authentication level integrating unit 401. The authentication verifying unit 402 performs verification by comparing a predetermined value with the integrated authentication level. If the integrated authentication level is greater than the predetermined value, the authentication target person is identified as a registered person. If the integrated authentication level is less than the predetermined value, the authentication verifying unit 402 outputs an alarm to the authentication level control unit 403. The authentication level control unit 403 requests the second authentication device 200 to authenticate again, based on the alarm outputted from the authentication verifying unit 402.

The second authentication device 200 acquires authentication information of the authentication target person again and calculates an authentication level. Then, the second authentication device 200 outputs the authentication level to the authentication verifying device 400. Upon receiving the authentication level, the authentication verifying device 400 integrates the integrated authentication level and the authentication level to calculate a reintegrated authentication level. Then, the authentication verifying unit 402 performs verification by comparing a predetermined value with the reintegrated authentication level. If the reintegrated authentication level is less than the predetermined value, the authentication verifying unit 402 outputs a further alarm to the authentication level control unit 403, which then requests the second authentication device to perform further authentication.

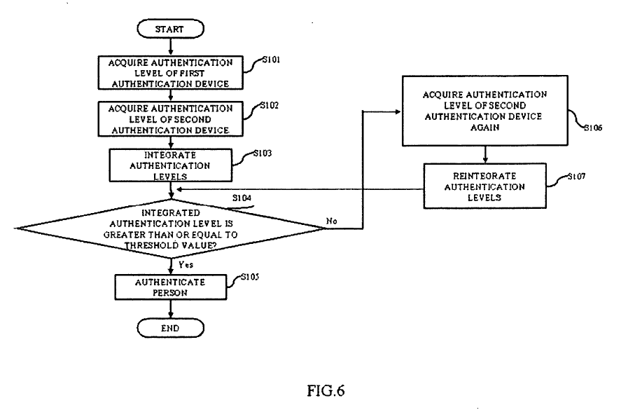

The operation of the authentication system of the present embodiment will be described in detail with reference to FIG. 6.

First, the first authentication device 100 acquires an authentication level of an authentication target person (S101). Then, the second authentication device 200 acquires an authentication level of the authentication target person in a similar manner (S102). The authentication level integrating unit 401 integrates the authentication levels acquired by the first authentication device 100 and the second authentication device 200 (S103). The authentication level integrating unit 401 may integrate authentication levels which are outputted from a plurality of authentication level calculating units 113, 123, 213, 223 included in the authentication device 100 and the authentication device 200. The authentication level integrating unit 401 sums and integrates all the authentication levels. Alternatively, the authentication level integrating unit 401 may select the maximum authentication level for each authentication device and sum and integrate the selected authentication levels.

The authentication verifying unit 402 compares the authentication level integrated by the authentication level integrating unit 401 with a predetermined threshold value of authentication level (S104). The threshold value may be above an integrated value of authentication levels outputted from some of the authentication devices. If the authentication level is greater than the threshold value, the authentication target person is determined to be a registered person (S105). If the authentication level is less than the threshold value in S104, the authentication verifying unit 402 outputs an alarm to the authentication level control unit 403. When receiving the alarm, the authentication level control unit 403 instructs the second authentication device to acquire an authentication level again. Then, second authentication device 200 acquires an authentication level again (S106). Then, the authentication level integrating unit 401 integrates the integrated authentication level and the authentication level acquired again (S107). This sequence of operations (S106, S107) is repeated until the integrated authentication level becomes greater than or equal to the threshold value in S104.

As described above, even if an authentication level obtained by the first authentication device is low in S101, the second authentication device acquires an authentication level until an integrated authentication level becomes greater than or equal to a threshold value. Therefore, minimum required authentication accuracy can be ensured. Further, since an authentication method which acquires a low authentication level is allowed in the first authentication device, highly convenient authentication can be performed.

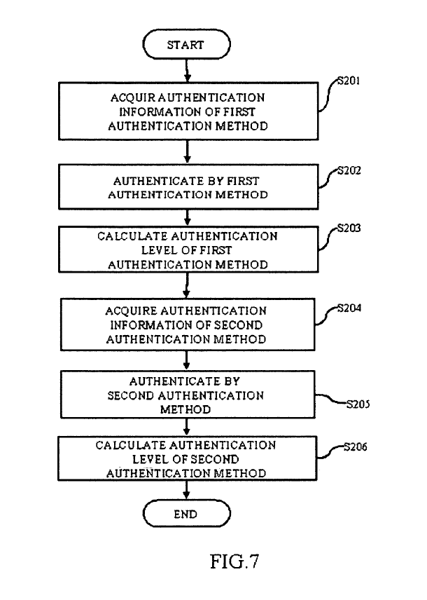

The operation of the first authentication device 100 to acquire an authentication level will be described in detail with reference to FIG. 7.

The authentication information acquiring unit 111 included in the first authentication unit 110 acquires authentication information of an authentication target person (S201). As authentication information, biologic information such as face, fingerprint, vein, palm print, iris, or voice print information may be used, or ID information such as an RFID tag or an optical ID tag may be used. The authentication unit 112 authenticates processing based on the acquired authentication information, and outputs an authentication result (S202). The authentication calculating unit 113 outputs an authentication level according to the authentication result received from the authentication unit 112 (S203). At this time, the authentication level may be controlled based on an authentication method. For example, because spoofing is easy in authentication using an ID tag if the ID tag is stolen, an authentication result using an ID tag may be weighted such that a relatively low authentication level is outputted. In addition, because spoofing is difficult in contact-type authentication using a fingerprint or veins, an authentication result in such contact-type authentication may be weighted relatively heavy such that a relatively high authentication level is outputted.

The authentication information acquiring unit 121 included in the second authentication unit 120 acquires authentication information of the authentication target person using an authentication method different from that of the first authentication unit 110 (S204). The authentication information may be, for example, biologic information or ID information that is different from that of the first authentication method. The authentication information acquired by the authentication information acquiring unit 121 is subjected to authentication processing by the authentication unit 122 (S205). The authentication level calculating unit 123 outputs an authentication level for the second authentication method (S206). Although acquisition of authentication information and calculation of authentication level are performed twice in the above example, acquisition of authentication information and calculation of authentication level may be performed only once or more than twice.

Next, the exemplary embodiment of an authentication system of the present invention will be described through a specific example. Description of components already described in the above embodiment will be omitted.

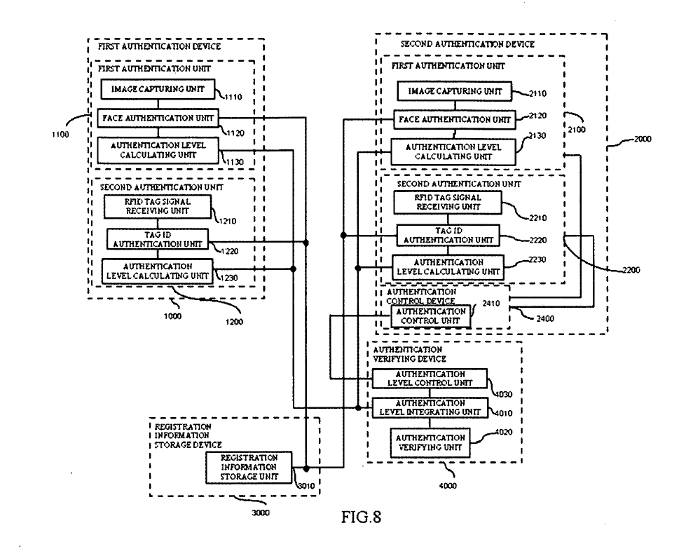

A configuration of a first example of the authentication system of the present invention will be described with reference to FIG. 8. The first example of the authentication system includes a first authentication device 1000, a second authentication device 2000, a registration information storage device 3000, and an authentication verifying device 4000.

The first authentication device 1000 includes a first authentication unit 1100 which performs face authentication processing and a second authentication unit 1200 which authenticates by RFID tag detection.

The first authentication unit 1100 includes an image capturing unit 1110, a face authentication unit 1120, and an authentication level calculating unit 1130. The image capturing unit 1110 captures a face image of an authentication target person using a camera or the like. The face authentication unit 1120 compares the image captured by the image capturing unit 1110 with a registered face image stored in a registration information storage unit 3010, and outputs an authentication result. The authentication level calculating unit 1130 calculates an authentication level of the authentication target person based on the authentication result outputted from the face authentication unit 1120. Then, the authentication level calculating unit 1130 outputs the authentication level to the authentication device 4000.

The second authentication unit 1200 includes an RFID tag signal receiving unit 1210, a tag ID authentication unit 1220, and an authentication level calculating unit 1230. The RFID tag signal receiving unit 1210 receives a signal of an RFID tag which authentication target person has. The tag ID authentication unit 1220 compares the tag ID received by the RFID tag signal receiving unit 1210 with a tag ID of a registered person stored in the registration information storage unit 3010. When the received tag ID matches the registered tag ID of the registered person, the tag ID authentication unit 1220 outputs an authentication result. The authentication level calculating unit 1230 outputs an authentication level of the authentication target person based on the authentication result outputted from the tag ID authentication unit 1220.

The second authentication device 2000 has the same configuration as the first authentication device 1000. The second authentication device 2000 includes a first authentication unit 2100 which performs face authentication processing and a second authentication unit 2200 which authenticates by RFID tag detection.

The registration information storage device 3000 includes a registration information storage unit 3010. The registration information storage unit 3010 stores preregistered person's face image and RFID tag information.

The authentication verifying device 4000 includes an authentication level integrating unit 4010, an authentication verifying unit 4020, and the authentication level control unit 4030. The authentication level integrating unit 4010 integrates authentication levels outputted from authentication level calculating units 1130, 1230, 2130, 2230, and outputs an integrated authentication level. The authentication verifying unit 4020 verifies whether an authentication target person is a registered person or not based on the integrated authentication level outputted from the authentication level integrating unit 4010. The method for this verification has already been described in the first embodiment.

The authentication level control unit 4030 controls an authentication level of each authentication method of the second authentication device based on authentication levels of respective authentication methods of the first authentication device.

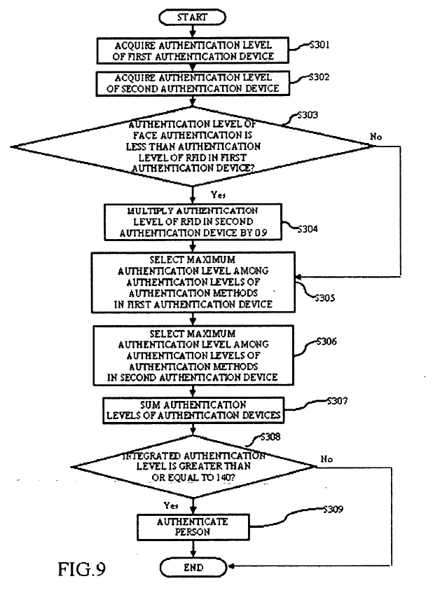

Operation of the first example of the authentication system of the present invention will now be described in detail with reference to FIG. 9.

First, the first authentication device 1000 acquires an authentication level of an authentication target person (S301). The second authentication device 2000 also acquires authentication levels of face authentication and authentication by RFID tag detection in the same manner as in 5301 (S302). The authentication level control unit 4030 compares the authentication level of face authentication of the first authentication device 1000 with the authentication level of RFID of the first authentication device 1000 both of which were outputted from the first authentication device 1000 (S303). If the authentication level of face authentication is less than the authentication level of RFID, the authentication level control unit 4030 weights to the authentication level of RFID of the second authentication device 2000 outputted from the second authentication device 2000 (S304). For example, as weighting, the authentication level of RFID of the second authentication device 2000 may be multiplied by 0.9. The authentication level integrating unit 4010 selects the maximum authentication level among the authentication levels outputted from the authentication level calculating unit 1130, 1230 of the first authentication device (S305). In addition, the authentication level integrating unit 4010 selects the maximum authentication level among the authentication levels of the second authentication device controlled by the authentication level control unit 4030 (S306). Alternatively, a statistic may be used instead of the maximum level.

The authentication level integrating unit 4010 sums the respective maximum authentication levels outputted from the first authentication device 1000 and the second authentication device 2000 to calculate an integrated authentication level (S307).

The authentication verifying unit 4020 compares the integrated authentication level calculated by the authentication level integrating unit 4010 with a threshold value (S308). The threshold value used here must be greater than the authentication level that is used in authentication performed independently by the first authentication device 1000 or the second authentication device 2000. For example, when the authentication level that is used in authentication performed independently by the first authentication device 1000 or the second authentication device 2000 is 100, the threshold value may be set to 140. If the integrated authentication level is greater than or equal to the threshold value, the authentication target person is determined to be a registered person (S309).

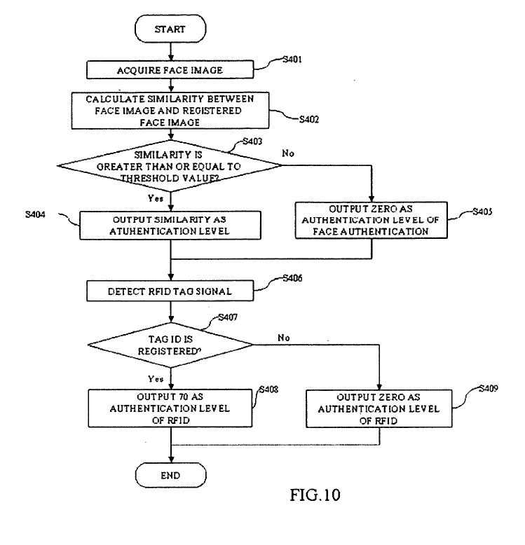

Operation of the first authentication device 1000 to acquire an authentication level will be described with reference to FIG. 10.

First, the image capturing unit 1110 included in the first authentication unit 1100 captures a face image of an authentication target person (S401). The face authentication unit 1120 compares the face image captured by the image capturing unit 1110 with each registered face image stored in a registration information storage unit 3010. Then, the face authentication unit 1120 calculates a similarity between each registered face image and the captured face image (S402). A similarity as used herein is an index value representing a relationship between each registered face image and the captured face image. For example, the similarity may be a normalized correlation value between a registered face image and a captured face image, or may be an index value representing a degree of similarity between each registered face image and the captured face image. The authentication level calculating unit 1130 compare the similarity calculated by the face authentication unit 1120 with a threshold value (S403). Then, if the similarity is greater than or equal to the threshold value, the authentication level calculating unit 1130 calculates an authentication level based on the similarity. The authentication level calculating unit 1130 outputs the authentication level (S404). For example, the authentication level may be calculated by multiplying the similarity by a constant such that the similarity has a value between 0 and 100. If the similarity is less than the threshold value, the authentication level calculating unit 1130 outputs zero as the authentication level of face authentication (S405). If the face is not found, the authentication level calculating unit 1130 outputs zero as the authentication level. When the influence of an impediment to face authentication is small, the authentication level calculating unit 1130 may output 70 as the authentication level of the face authentication result. In other words, the authentication level calculating unit 1130 may be configured to output a lower authentication level when the influence of the impediment is large, and output a higher authentication level when the influence of the impediment is small. Examples of impediments include a face direction, lighting, and overlapping of a plurality of persons. Additionally, the authentication level calculating unit 1130 may take into account that the impediments can be reduced because of an authentication target person's cooperation. Further, as a method for converting a similarity to an authentication level, a method different from the above described conversion methods may be employed.

Then, the RFID tag signal receiving unit 1210 included in the second authentication unit 1200 receives a tag ID of the authentication target person (S406). Then, the tag ID authentication unit 1220 compares the received tag ID with a tag ID stored in the registration information storage unit 3010, and outputs an authentication result (S407). If the received tag ID matches the registered tag ID, the authentication level calculating unit 1230 outputs an authentication level of 70 (S408). Alternatively, for example, the authentication level calculating unit 1230 may calculate an authentication level of RFID tag by normalizing a reception strength of a tag signal in the range of 0 to 70. If the tag ID has not been registered in step S407, the authentication level calculating unit 1230 outputs zero as the authentication level of the second authentication unit (S409). In addition, if the tag is not detected, the authentication level calculating unit 1230 outputs zero as the authentication level. The RFID tag may be, for example, a tag which includes a power source and originates a signal. This type of tag allows authentication without an operation to bring the RFID tag dose to the detector. Therefore, when the first authentication device 1000 is installed on an entrance door, and its detection area is the whole area around the entrance door, omission of detection is prevented.

In the authentication system of the present example, only with an authentication result from one of a plurality of authentication devices, a whole authentication level does not become greater than or equal to a threshold, and the authentication target person is not authenticated as a registered person. In other words, the sum of authentication levels of authentication results of the first authentication device 1000 and the second authentication device 2000 is required to become greater than or equal to the threshold. Therefore, minimum required authentication accuracy can be ensured.

Further, for example, the second authentication device 2000 may be installed on the exit door while the first authentication device 1000 may be installed on the entrance door. In this case, authentication must be performed at the time of entrance as well as at the time of exit. Thereby, anti-passback function can be ensured. Thus, in the exemplary embodiment the authentication system of the present invention, a not high authentication level of the first authentication device 1000 is allowed, so that highly convenient authentication is provided. Further, even if authentication level of an authentication result from one authentication device is low due to an impediment, authentication can be performed when an integrated result of authentication levels of the first and second authentication devices is sufficient. Thereby, the convenience can be enhanced.

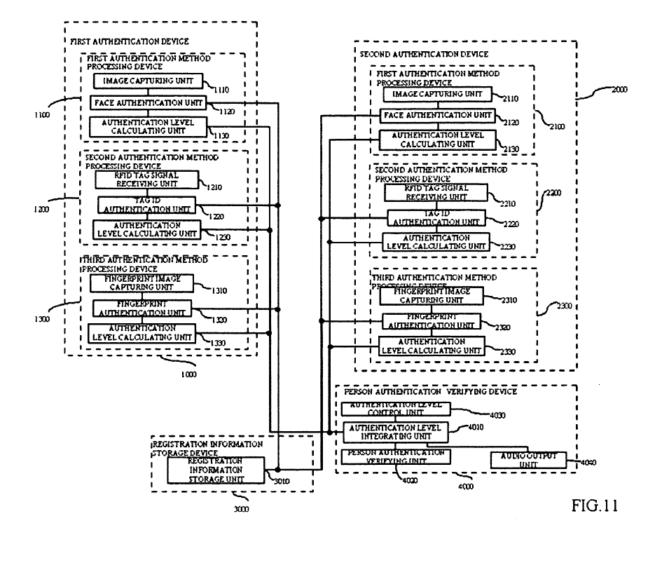

An exemplary configuration of a second example of the authentication system of the present invention will be described in detail with reference to FIG. 11. The authentication system of the second example is different from that of the first example in that the authentication system of the second example includes third authentication units 1300, 2300 and an audio output unit 4040.

The first authentication device 1000 includes the first authentication unit 1100 which performs face authentication processing, the second authentication unit 1200 which authenticates by RFID tag detection, and a third authentication unit 1300 which performs fingerprint authentication processing. The first authentication unit 1100 and the second authentication unit 1200 have the same configurations as in the first authentication device of the first example, and description thereof will be omitted. The third authentication unit 1300 includes a fingerprint image capturing unit 1310, a fingerprint authentication unit 1320, and an authentication level calculating unit 1330.

The fingerprint image capturing unit 1310 captures a fingerprint image of an authentication target person. The fingerprint image capturing unit 1310 may be a contact-type sensor. The fingerprint authentication unit 1320 compares the fingerprint image captured by the fingerprint image capturing unit 1310 with each fingerprint image stored in a registration information storage unit 3010 to calculate a similarity. The authentication calculating unit 1330 calculates an authentication level based on the similarity outputted from the fingerprint authentication unit 1320. The authentication calculating unit 1330 outputs the calculated authentication level.

The second authentication device 2000 has the same configuration as the first authentication device 1000, and description thereof will be omitted.

The registration information storage unit 3010, the authentication level integrating unit 4010, the authentication verifying unit 4020, and the authentication level control unit 4030 have the same configurations as in the first example, and description thereof will be omitted.

The audio output unit 4040 outputs audio for prompting authentication by an authentication method having a higher authentication level, based on the authentication level outputted from the authentication calculating unit.

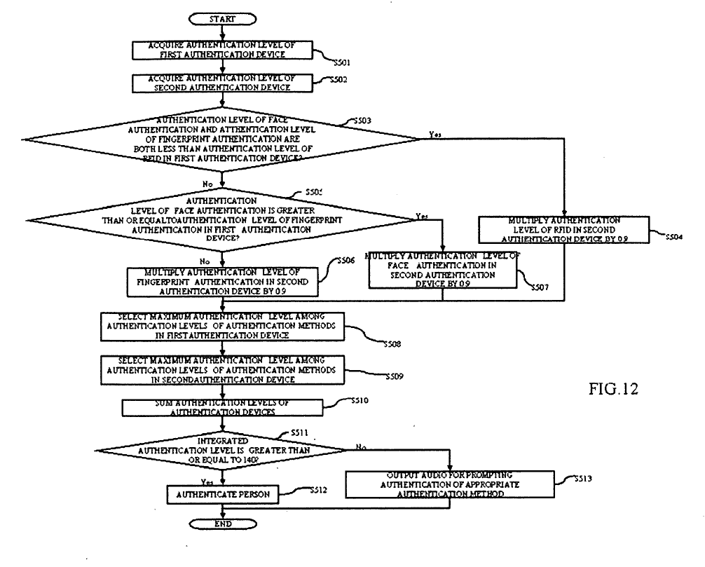

The operation of the second example will now be described in detail with reference to FIG. 12.

First, the first authentication device 1000 acquires authentication levels of face authentication, authentication by RFID tag detection, and fingerprint authentication (S501).

The second authentication device 2000 acquires authentication levels of face authentication, authentication by RFID tag detection, and fingerprint authentication in the same manner as in 5501 (S502).

The authentication level control unit 4030 compares the authentication levels of face authentication and fingerprint authentication with the authentication level of RFID, from among authentication levels of the first authentication device 1000 outputted from the first authentication device 1000 (S503). If the authentication level of RFID is highest, the authentication level of RFID of the second authentication device is weighted (S504). For example, as weighting, the authentication level of RFID of the second authentication device 2000 may be multiplied by 0.9. If it is not highest, the authentication level control unit 4030 compares the authentication level of face authentication with the authentication level of fingerprint authentication (S505). If the authentication level of fingerprint authentication is higher, the authentication level of fingerprint authentication of the second authentication device 2000 is weighted (S506). For example, as weighting, the authentication level of fingerprint authentication of the second authentication device 2000 may be multiplied by 0.9. If the authentication level of face authentication is greater than or equal to the authentication level of fingerprint authentication, the authentication level of face authentication of the second authentication device 2000 is weighted (S507). For example, as weighting, the authentication level of face authentication of the second authentication device 2000 may be multiplied by 0.9. Accordingly, an authentication level is lowered when the same authentication method is used in the first and second authentication devices, so that spoofing is made difficult.

Steps S508 to 5510 of FIG. 12 are performed in the same manner as steps S305 to S307 of the first example, and description thereof will be omitted.

The authentication verifying unit 4020 compares an authentication level integrated by the authentication level integrating unit 4010 with a threshold value (S511). If the authentication level is greater than or equal to the threshold value, the authentication verifying unit 4020 verifies the authentication target person is a registered person (S512). If the authentication level is less than the threshold value, the audio output unit 4040 outputs audio for prompting authentication by an appropriate authentication method (S513). The threshold value used here must be greater than the authentication level that is used in authentication performed independently by the first authentication device 1000 or the second authentication device 2000. For example, when the authentication level that is used in authentication performed independently by the first authentication device 1000 or the second authentication device 2000 is 100, the threshold value may be set to 140. For example, an appropriate authentication method independently used by the first authentication device 1000 or the second authentication device 2000 may be fingerprint authentication, which can achieve high authentication accuracy although contact is required.

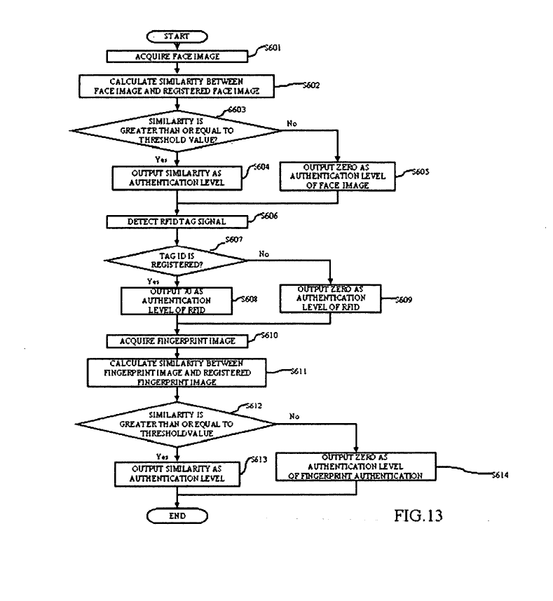

The operation of the first authentication device 1000 of the authentication system in the present example will be described in detail with reference to FIG. 13. Of the operation of the first authentication device 1000 of the authentication system in the present example shown in FIG. 13, steps S601 to S609 are performed in the same manner as steps S401 to S409 in the first example. Therefore, description of steps S601 to S609 will be omitted.

Then, the fingerprint image capturing unit 1310 captures a fingerprint image of an authentication target person (S610). For example, the fingerprint image capturing unit 1310 may capture a fingerprint image suitable for authentication using a contact-type photographic device.

The fingerprint authentication unit 1320 compares the fingerprint image captured by the fingerprint image capturing unit 1310 with each fingerprint image stored in the registration information storage unit 3010 to calculate a similarity (S611). For example, the fingerprint authentication unit 1320 may calculate, as the similarity, a normalized correlation value between the registered fingerprint image and the captured fingerprint image. The authentication level calculating unit 1330 compares the similarity calculated by the fingerprint authentication unit 1320 with a threshold value (S612). If the similarity is greater than or equal to the threshold value, the authentication level calculating unit 1330 calculates an authentication level based on the similarity. Then, the authentication level calculating unit 1330 outputs the calculated authentication level (S613). If the similarity is less than the threshold value, the authentication level calculating unit 1330 outputs zero as the authentication level of fingerprint authentication (S614). For example, the authentication level may be calculated by multiplying the similarity by a constant such that the similarity has a value between 0 and 100. If the fingerprint image cannot be acquired, the authentication level calculating unit 1330 outputs zero as the authentication level. As a method for converting a similarity to an authentication level, a method different from the above methods may be employed.

According to the present example, the advantages of the first example is achieved, and furthermore, when face authentication is difficult due to an impediment, fingerprint authentication with high authentication accuracy is used so that minimum required authentication accuracy can be ensured. In addition, a unit which prompts an appropriate authentication method if an integrated authentication level is not sufficient is provided to help an authentication target person select an appropriate authentication method, so that the convenience can be enhanced.

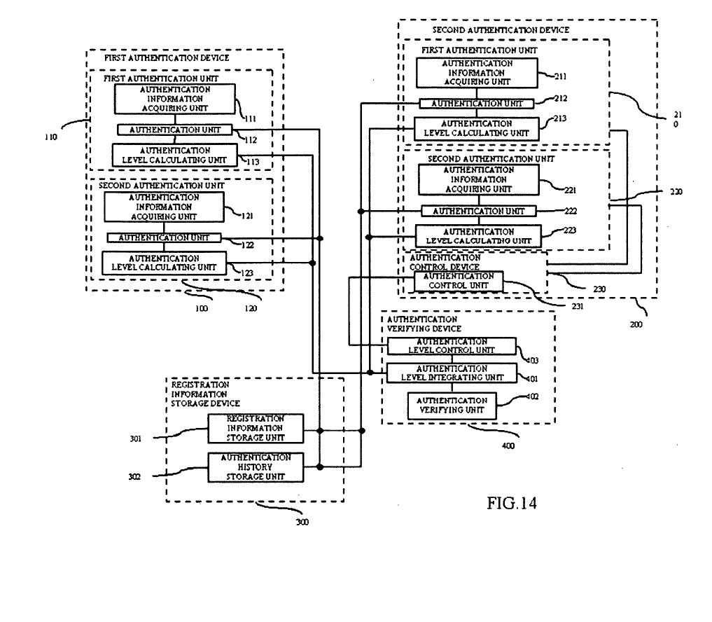

Further, a third exemplary embodiment of the authentication system of the present invention will be described with reference to FIG. 14. Description of the same components as in the first embodiment will be omitted.

In the authentication device of the present embodiment, the registration information storage device 300 includes the registration information storage unit 301 and an authentication history storage unit 302. The registration information storage unit 301 is the same as in the first embodiment, and description thereof will be omitted. In the authentication history storage unit 302, past authentication history information of an authentication target person is stored. Authentication history information is stored in association with person information stored in the registration information storage unit 301.

The authentication units 112, 122, 212, 222 compare authentication information with registered authentication information, and output an authentication result. At this time, the authentication units 112, 122, 212, 222 weight to the authentication result using the authentication history information. For example, when a person authenticated in the past is authenticated as an authentication target person, a weight is assigned such that an authentication level becomes higher. The authentication units 112, 122, 212, 222 may weight based on an elapsed time from previous authentication. For example, an authentication level may be weighted such that if one day has passed from previous authentication, the authentication level increases, and if one month has passed from previous authentication, the authentication level decreases.

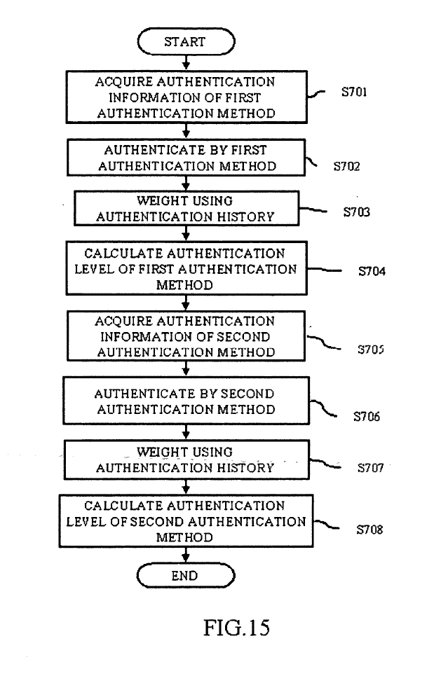

The operation of the first authentication device 100 will be described in detail with reference to FIG. 15. Description of the steps already described in FIG. 7 will be omitted.

The authentication unit 112 receives an authentication result from the authentication information acquiring unit 111 included in the first authentication processing device 110, and weights to the authentication result using authentication history information (S703). The authentication unit 122 receives an authentication result from the authentication information acquiring unit 121 included in the second authentication processing device 120, and weights to the authentication result using authentication history information (S707).

The authentication system of the present embodiment authenticates based on a history of authentication. Therefore, if an elapsed time from previous authentication is short, an authentication level can easily be greater than or equal to a threshold value, so that the convenience is further enhanced.

Although the exemplary embodiment of the present invention has been described through the exemplary embodiments and examples, the present invention is not limited to the above described embodiments and examples, and various modifications may be made within the spirit and scope of the present invention.

The present invention has been described in detail. However, it should be appreciated that various changes may be made to the present invention without departing from its spirits and be covered by the claims.

Furthermore, it is the inventor's intent to retain all equivalents of the claimed invention even if the claims are amended during prosecution.

What is claimed is:

1. An authentication system comprises:
a first authentication device which acquires a first authentication level;
a second authentication device which acquires a second authentication level; and
an authentication verifying device which authenticates based on a comparison between a predetermined value and a sum of the first authentication level and the second authentication level.

2. The authentication system according to claim 1, wherein the second authentication device comprises a plurality of authentication units.

3. The authentication system according to claim 2, wherein if the sum of the first and second authentication levels is less than the predetermined value, the second authentication device acquires a third authentication level using an authentication unit different from an authentication unit which acquires the second authentication level.

4. The authentication system according to claims 1, wherein an authentication unit of the first authentication device includes one of face authentication, RFID authentication, and fingerprint authentication.

5. The authentication system according to claims 1, wherein an authentication unit of the second authentication device includes face authentication, RFID authentication, or fingerprint authentication.

6. The authentication system according to claims 1, wherein the first authentication level or the second authentication level is weighted based on authentication history information.

7. An authentication method comprising the steps of:
acquiring a first authentication level by a first authentication device;
acquiring a second authentication level by a second authentication device; and
authenticating based on a sum of the first authentication level and the second authentication level.

8. The authentication method according to claim 7, wherein the second authentication device comprises a plurality of authentication units.

9. The authentication method according to claim 8, further comprising the step of, if the sum of the first and second authentication levels is less than the predetermined value, acquiring a third authentication level using an authentication unit different from an authentication unit which acquires the second authentication level.

10. The authentication method according to claims 7, wherein an authentication unit of the first authentication device includes one of face authentication, RFID authentication, and fingerprint authentication.

11. The authentication method according to claims 7, wherein an authentication unit of the second authentication device includes face authentication, RFID authentication, or fingerprint authentication.

12. The authentication method according to claims 7, wherein the first authentication level or the second authentication level is weighted based on authentication history information.

13. An authentication program which causes a computer to execute:
first authentication level acquisition processing for acquiring a first authentication level by a first authentication device;
second authentication level acquisition processing for acquiring a second authentication level by a second authentication device; and
authentication processing for authenticating based on a sum of the first authentication level and the second authentication level.

14. The authentication program according to claim 13, wherein the second authentication device comprises a plurality of authentication units.

15. The authentication program according to claim 14, further causing the computer to execute third authentication level acquisition processing for, if the sum of the first and second authentication levels is less than the predetermined value, acquiring a third authentication level by the second authentication device using an authentication unit different from an authentication unit which acquires the second authentication level.

16. The authentication program according to claims 13, wherein an authentication unit of the first authentication device includes one of face authentication, RFID authentication, and fingerprint authentication.

17. The authentication program according to claims 13, wherein an authentication unit of the second authentication device includes face authentication, RFID authentication, or fingerprint authentication.

18. The authentication program according to claims 13, wherein the first authentication level or the second authentication level is weighted based on authentication history information.
